(19) United States
(12) Patent Application Publication
(10) Pub. No.: US 2005/0070256 A1
(43) Pub. Date: Mar. 31, 2005

(54) Method of dynamic rate splitting

(76) Inventor: Teck Hu, Budd Lake, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/673,932

(22) Filed: Sep. 29, 2003

(51) Int. Cl. H04Q 7/20

(52) U.S. Cl. 455/414.1

(57) ABSTRACT

A method of wireless communication. The method may involve a number of multicast service subscribers. In one embodiment, the method includes assigning at least one multicast rate to each multicast service subscriber. The assigned multicast rate, by this method, corresponds with determining channel conditions, power requirements, desired content and/or the multicast service subscription type for each subscriber. In another embodiment, the method includes receiving a multicast subscription service at an assigned multicast rate. The assigned multicast rate here corresponds with the multicast subscription type, desired content, channel conditions, power requirements, other services and/or equipment class of the user.

### BACKGROUND OF THE INVENTION

I. Field of the Invention

The present invention relates to telecommunications, and more particularly, to wireless communications.

II. Description of the Related Art

Wireless communications systems provide wireless service to a number of wireless or mobile units situated within a geographic region. The geographic region supported by a wireless communications system is divided into spatially distinct areas commonly referred to as “cells.” Each cell, ideally, may be represented by a hexagon in a honeycomb pattern. In practice, however, each cell may have an irregular shape, depending on various factors including the topography of the terrain surrounding the cell. Moreover, each cell is further broken into two or more sectors. Each cell is commonly divided into three sectors, each having a range of 120 degrees, for example.

A conventional cellular system comprises a number of cell sites or base stations geographically distributed to support the transmission and reception of communication signals to and from the wireless or mobile units. Each cell site handles voice communications within a cell. Moreover, the overall coverage area for the cellular system may be defined by the union of cells for all of the cell sites, where the coverage areas for nearby cell sites overlap to ensure, where possible, contiguous communication coverage within the outer boundaries of the system's coverage area.

Each base station comprises at least one radio and at least one antenna for communicating with the wireless units in that cell. Moreover, each base station also comprises transmission equipment for communicating with a Mobile Switching Center (“MSC”). A mobile switching center is responsible for, among other things, establishing and maintaining calls between the wireless units, between a wireless unit and a wireline unit through a public switched telephone network (“PSTN”), as well as between a wireless unit and a packet data network (“PDN”), such as the Internet. A base station controller (“BSC”) administers the radio resources for one or more base stations and relays this information to the MSC.

When active, a wireless unit receives signals from at least one base station over a forward link or downlink and transmits signals to at least one base station over a reverse link or uplink. Several approaches have been developed for defining links or channels in a cellular communication system, including time-division multiple access (“TDMA”), code-division multiple access (“CDMA”) and orthogonal-frequency division multiple access (“OFDMA”), for example.

In TDMA communication systems, the radio spectrum is divided into time slots. Each time slow allows only one user to transmit and/or receive. Thusly, TDMA requires precise timing between the transmitter and receiver so that each user may transmit their information during their allocated time.

In a CDMA scheme, each wireless channel is distinguished by a distinct channelization code (e.g., spreading code, spread spectrum code or Walsh code). Each distinct channelization code is used to encode different information streams. These information streams may then be modulated at one or more different carrier frequencies for simultaneous transmission. A receiver may recover a particular stream from a received signal using the appropriate channelization code to decode the received signal.

In OFDMA systems, a carrier signal may be defined by a number (e.g., 1024) of sub-carriers or tones transmitted using a set of mathematically time orthogonal continuous waveforms. Each wireless channel may be distinguished by a distinct channelization tone. By employing orthogonal continuous waveforms, the transmission and/or reception of the tones may be achieved, as their orthogonality prevents them from interfering with one another.

With the explosion of wireless telephony, service providers have been exploring new growth opportunities. One such prospect has centered on providing subscription-based services to wireless users. For the purposes of the present disclosure, subscription-based services may require a subscription and/or additional fees from the service provider or content provider to gain access the service(s). Moreover, subscription-based services may provide tiers of service.

One example of a subscription-based service may be multicast services. For the purposes of the present disclosure, multicast services correspond to the transmission of content by one source to multiple receivers having privileges (e.g., subscribers). Multicast services, such as Multimedia Broadcast Multicast Services (“MBMS”), for example, may be provide growth prospects by offering multimedia content anywhere within the cell with a subscription. In one example, multimedia content, such as streaming video and/or audio, may be multicast from an entertainment or news service provider to subscribers through the wireless communications network using MBMS.

Multicast services, however, raise issues regarding infrastructure. To make a multicast service available to wireless users within the cell may require a substantial bandwidth increase. Moreover, multicast services may be relatively delay-intolerant, requiring near-real-time transmission and reception. Multicast services, such as MBMS, may also require significant resources, including transmit power, from the network infrastructure, such as a wireless network's base station (e.g., Node B), to enable each of the privileged multiple receivers to access the premium service.

Consequently, a demand exists for a method of supporting subscription-based services, such as multicast services, which may reduce power consumption.

### SUMMARY OF THE INVENTION

The present invention provides a method of supporting subscription-based services, such as multicast services, that may increase power conservation. More particularly, the method of the present invention provides a rate splitting technique to reduce continuous demand on the resources of the network infrastructure elements, such as a wireless network's base station. For the purposes of the present disclosure, rate splitting may correspond with dividing a subscription-based service, such as a multicast service, into at least a first and a second service type, each service type offering a different grade of quality and/or content and/or service rate, such as a service rate (e.g., multicast rate). It should also be noted that each multicast rate, for the purposes of the present disclosure, might correspond with one of several multicast streams of content and/or one of several rates in which the stream(s) of content may be multicast. In an illustrative example of rate splitting for multicast services, a basic service and a premium service are supported, where the basic service may offer monochrome images at a first multicast rate, while the premium service may offer streaming color images at a second multicast rate relatively higher than the first multicast rate.

In an exemplary embodiment, a method of the present invention includes assigning at least one service rate to each of a number of subscription-based service types, such as multicast service subscription types, that may be in the cell. This step of assigning relies on rate splitting by considering one or more factor(s) associated with each subscriber, such as, channel conditions, power requirements, a service subscription type, desired content and/or equipment class for each subscriber. Moreover, the geographical distribution and/or subscription distribution of the number of service subscribers within the cell may also be considered in assigning the service rate to each subscription-based service type.

In another exemplary embodiment, a method of the present invention includes receiving a subscription-based service, such as a multicast subscription service, at an assigned service rate (e.g., multicast rate). Here, the assigned service rate corresponds with the subscription type (e.g., basic and/or premium), desired content, channel conditions, power requirements, other services and/or equipment class of the service subscriber. The assigned service rate may also correspond with the geographical distribution and the subscription distribution of the service subscribers within a cell.

Consequently, a method is provided for varying the service types or grades of quality and/or content thru the use of rate splitting. For example, cell coverage may be varied for different service types to conserve resources of the network infrastructure elements, such as power at the base station. Likewise, the content that is multicast may be scaled (e.g., pared down by offering monochrome images in place of streaming color images) to reduce power consumption. The service types or grades available may also be varied in response to the power consumed at the base station, for example. At the wireless unit, the service type may be varied, for example, based on the other services the user may be concurrently accessing. Likewise, the wireless unit may autonomously scale the service type upward or down based on the power required.

These and other embodiments will become apparent to those skilled in the art from the following detailed description read in conjunction with the appended claims and the drawings attached hereto.

### BRIEF DESCRIPTION OF THE DRAWINGS

The present invention will be better understood from reading the following description of non-limiting embodiments, with reference to the attached drawings, wherein below:

FIG. 1 depicts a block diagram of a network architecture supporting the present invention;

FIG. 2 depicts a flow chart according to one embodiment of the present invention; and

FIG. 3 depicts a flow chart according to another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention provides a method of supporting subscription-based services, such as multicast services, that may increase power conservation. More particularly, the method employs a rate splitting technique to reduce a continuous demand on the resources of the network infrastructure elements, such as a wireless network's base station (e.g., Node B). It should be noted that rate splitting may correspond with dividing a subscription-based service, such as a multicast service, into at least a first and a second service type, each service type offering a different grade of quality and/or content and/or service rate (e.g., multicast rate). For the purposes of the present disclosure, each multicast rate might correspond with one of several multicast streams of content and/or one of several rates in which the stream(s) of content may be multicast.

By way of the present invention, a method is provided for varying service types or grades thru the use of rate splitting. For example, cell coverage may be varied for different service types to conserve resources of the network infrastructure elements, such as the power at the base station. Likewise, the content multicast may be pared down (e.g., offering monochrome images in place of streaming color images) to reduce power consumption. The service types or grades available may also be varied in response to the power consumed at the base station, for example. At the wireless unit, the service type may be varied, for example, based on the other services the user may be concurrently accessing.

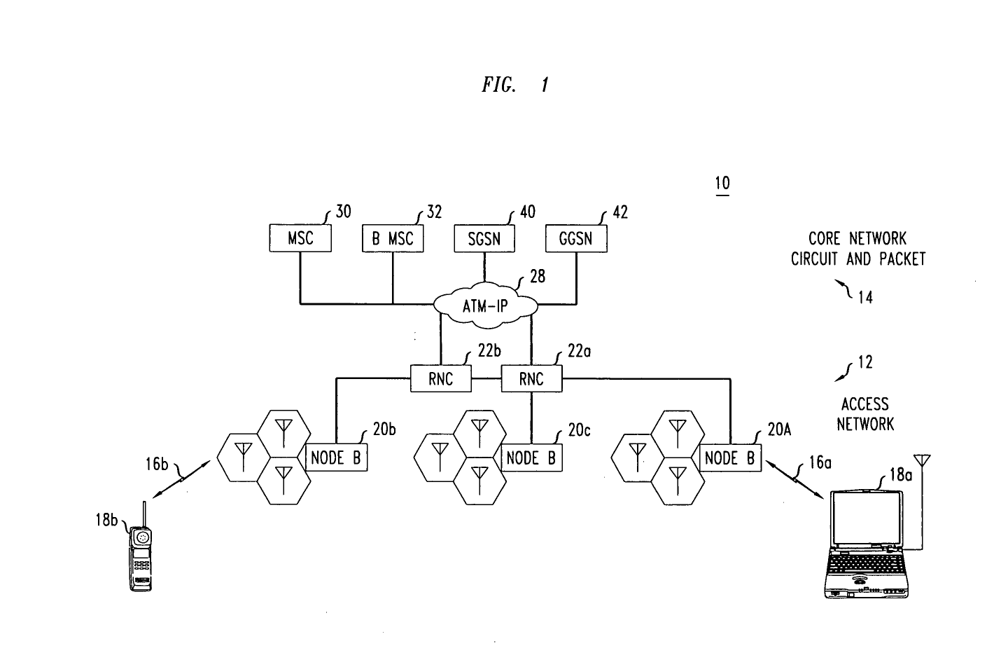

Referring to FIG. 1, a typical wireless communications network 10 supportive of multicast services is shown. Here, wireless communications network 10 may accommodate one of a number of architectures, including CDMA2000 and Universal Mobile Telecommunications System (“UMTS”), for example. Network 10 may be divided into a radio access network (“RAN”) 12 and a core network 14. RAN 12 includes equipment used to support wireless interfaces, 16a and 16b, between multicast supportive, wireless units, 18a and 18b, and network 10. Furthermore, RAN 12 comprises a plurality of base stations or Node Bs, 20a through 20c, as well as a number of radio network controllers (“RNCs”) or base station controllers (“BSCs”), 22a and 22b. The signaling exchange between the Node Bs and RNCs is commonly referred to as the I_{ub} interface, while the interface between RNCs themselves is commonly referred to as the Iᵤᵣ interface. The transport mechanism of both the I_{ub} and Iᵤᵣ interfaces may be generally based on an asynchronous transfer mode (“ATM”) scheme.

Core network 14 includes network elements that support circuit based communications, as well as packet-based communications. In establishing a typical circuit channel to handle circuit-based communications between wireless unit 18b and a public switched telephone network (“PSTN”) or another wireless unit, for example, base station 20b may receive (in the uplink) and transmit (in the downlink) coded information (e.g., circuit voice or circuit switched data). This coded information may be transmitted over wireless interface or link 16b.

RNCs 22a and 22b may each perform a number of functions. These functions may include, for example, frame selection, encryption, and handling of access network mobility. In establishing a typical circuit channel to handle circuit-based communications, RNC 22b may, for example, forward the circuit voice and circuit switched data over a network, such as an asynchronous transfer mode (“ATM”)/Internet Protocol (“IP”) network to a mobile switching, center (“MSC”) 30. MSC 30 is responsible for call processing and macromobility on the MSC level. MSC 30 initiates the connectivity between wireless unit 18b and the PSTN 24, for example.

In establishing a packet channel to handle packet-based communications between wireless unit 18a and a packet data network (“PDN”), such as the Internet, base station 20a receives (in the uplink) and transmits (in the downlink), the coded information over the wireless interface or link 16a. In the uplink direction, RNC 22a reassembles the packets as sent by wireless unit 18a and forwards them to a Serving GPRS Support Node (“SGSN”) 40. In the downlink direction, RNC 22a receives the packets and segments them into the right size packet to be transferred to the base station, which may perform its processing and the data across the wireless link 16a. SGSN 40 provides packet data session processing and macromobility support for network 10. SGSN 40 establishes connectivity between wireless unit 18a and the PDN, for example. A Gateway GPRS Support Node (“GGSN”) 42 may be employed to act as the gateway to external PDNs. Upon request from SGSN 40, GGSN 42 may establish a packet data protocol (PDP) session.

As shown, core network 14 also employs network elements supportive of multicast services. More particularly, core network 14 also includes a broadcast mobile switching center (“BMSC”) 32. BMSC 32 is responsible for processing and macromobility of the multimedia content to be multicast. BMSC 32 establishes connections between each wireless subscriber receiving a multicast—e.g., wireless units 18a and 18b—and a service provider generating and transmitting the multimedia content through core network 14. These established multicast connections are managed by RNC, 22a and 22b. In this scenario, each RNC, 22a and 22b, may perform rate splitting to conserve network resources, such as power consumption at base stations, 20a and 20c, for example. Alternatively, rate splitting may be performed further upstream, at BMSC 32, for example.

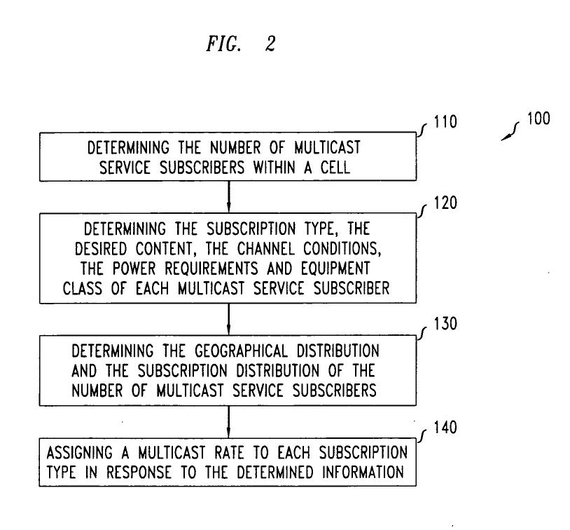

Referring to FIG. 2, an exemplary flow chart 100 of an embodiment of the present invention is illustrated. More particularly, flow chart 100 depicts a method of dynamic rate splitting. While flow chart 100 is described in conjunction with multicast services, such as MBMS, it should be apparent to skilled artisans that the scheme presented may be employed in concert with any service that benefiting from different service types, leveis or grades, for example.

The method corresponding with flow chart 100 initially determines the number of multicast service subscribers within a cell area of coverage (step 110). This determining step may be realized by any one of a number of means. For example, upon logging into the network, each wireless unit subscriber may convey its subscription(s) to a corresponding base station. This subscription information may be transmitted to a base station controller, which, in turn, may transmit this information to a mobile switching center.

Once the number of subscribers is ascertained, the method may then determine information about each subscriber (step 120). Individual subscriber information may indirectly illustrate the potential demands on wireless network infrastructure in supporting a multicasting service, for example, such as MBMS. By this step, information such as subscription type, desired content, channel condition, power requirements, other services and/or equipment class for each multicast subscriber may be determined. It should be noted that this step of determining additional information might be performed during or after the step of determining the number of multicast service subscribers.

Use of subscription type information may correspond with a rate splitting technique. Here, a service may be divided into at least a first and a second service type, such as basic, and premium service types. Each subscription service type each may offer a varying degree or grade of quality and/or content and/or multicast data rate for the subscribed service relative to the other. For example, a basic service and a premium service are supported, where the basic service may offer monochrome images at least a first multicast rate, while the premium service may offer streaming color images at least a second multicast rate relatively higher than the first multicast rate. Consequently, each subscription type may correspond with supporting at least one multicast rate.

Moreover, desired content may also be employed in conjunction correspond with a rate splitting technique. Here, the user of a wireless unit may be a subscriber to a higher grade of quality and/or content and/or multicast data rate but wish to access a relatively lower subscription service type. Reasons for selecting a lower grade service may include fees or multicast access time charges, for example.

The channel condition of each wireless unit may also be determined during this step. The channel condition may be a reflection of the attenuation patterns from the perspective of the wireless unit subscriber and/or the base station covering the relevant cell. The channel condition may be derived from a channel quality information signal corresponding with a signal-to-noise or signal-to-interference ratio.

Each wireless unit subscriber may have minimum power requirements to operate within the cell. Considerations regarding minimum power requirements may include signal strength from the perspective of the wireless unit subscriber and/or the base station covering the relevant cell. Additionally, these power requirements may also be conditioned on the location of the unit relative to the base station. If the wireless unit is mobile, these power requirements may vary with time.

Subscriber specific information may also include other services. Each subscriber, during this determining step, may be accessing one or more other wireless services. For example, one subscriber may be receiving a voice call, while also accessing high-speed downlink packet access (“HSDPA”) and/or high-speed uplink packet access services (“HSUPA”).

Furthermore, each subscriber may have information associated with its particular equipment class. While operating within the wireless network, subscribers may be built with the capability to process one or more channelization terms—channelization codes (CDMA) and/or tones (OFDMA). Consequently, the number of channelization terms attributed to each subscriber may correspond with the equipment class of the subscriber.

With particulars for each subscriber determined, the method may then determine other information regarding the subscriber populace within the cell (step 130). Subscriber populace information may directly illustrate the potential demands on the network infrastructure in supporting a multicasting service, for example, such as MBMS. It should be once again noted that this step of determining might be performed during or after the step of determining the number of multicast service subscribers and/or during or after the step of subscriber information.

By this step of determining subscriber populace information, the geographical distribution of the number of subscribers may be ascertained. For example, the geographical distribution may include subscribers within close proximity of the cell's associated base station requiring fewer network resources for multicasting, subscribers at the outer periphery of the cell's associated base station requiring greater network resources for multicasting, or some variation in geographical distribution therebetween.

Moreover, this step of determining subscriber populace information may also establish subscription distribution within the cell. Here, the subscription type for each of the subscribers may be grouped and subsequently examined. Alternatively, subscription distribution may be subsequently examined in conjunction with other individual subscriber or subscriber populace information, such as, for example, geographical distribution of subscribers.

Once individual subscriber and subscriber populace information have been determined, the present rate splitting method may then be completed. More particularly, the method assigns a multicast rate to each multicast service subscription type (step 140). Consequently, the desired information may be multicast to service subscribers of each service subscription type at the corresponding multicast rate assigned. As noted herein, for the purposes of the present disclosure, multicast rate may correspond with one of several multicast streams of content and/or one of several rates in which the stream(s) of content may be multicast.

In an effort to conserve network infrastructure resources and/or the resources at the user subscriber's wireless unit, the multicast rate assigned to each multicast service subscription type may take the individual subscriber and/or subscriber populace information into consideration. Thusly, while each subscriber may have a service type corresponding with one or more particular multicast rates, the multicast rate assigned to that multicast service subscription type may vary in accordance with individual subscriber and/or subscriber populace information. This varying of a multicast rate to each subscription type may involve prioritization. Here, the multicast rate assigned to each multicast service subscription type may aim to maximize the total number of subscribers that may receive the multicast. Alternatively, prioritization may take into consideration the goal of offering subscribers with the highest service level (or lowest service level) a maximum multicast rate first before addressing the remaining lower service level(s).

Various other combinations are contemplated herein by the present disclosure. For example, the availability of one or more multicast service subscription types may be also scaled. This scaling may be performed in response to base station resources in use, such as transmit power. As a consequence, this scaling step may include dropping and/or adding the availability of at least one of the multicast service subscription types.

In an alternate example of prioritization, the availability of at least one multicast service subscription type may be scaled in response to a demand from the multicast service subscribers associated with at least another the multicast service subscription type. This demand may correspond with power or subscription revenue, for example. Thusly, the step of scaling may include dropping and/or adding the availability of at least one of the multicast service subscription types before performing the step of assigning.

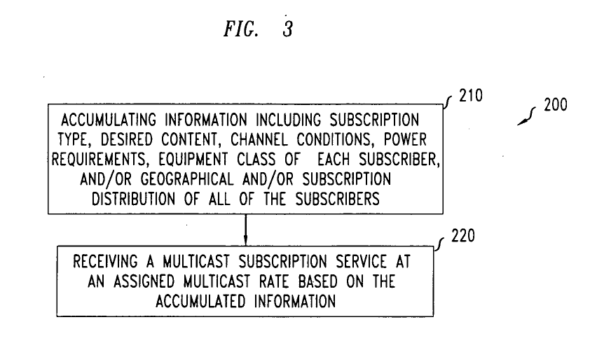

Referring to FIG. 3, an exemplary flow chart 200 of another embodiment of the present invention is illustrated. More particularly, flow chart 200 depicts a method of dynamic rate splitting. It should be noted that while flow chart 200 is described in conjunction with multicast services, such as MBMS, the method presented may be employed in concert with any service that benefiting from different service types, levels or grades, for example.

The method corresponding with flow chart 200 initially involves accumulating subscriber specific information to the wireless network, such as, for example, the base station controller by means of the base station (step 210). The subscriber specific information here may include the subscription type (e.g., basic, enhanced or premium), the desired content (e.g., black and white images or streaming color), the channel conditions (e.g., signal to noise or signal to interference ratio), power requirements (e.g., including signal strength from the perspective of the wireless unit subscriber and/or the base station), other services (e.g., voice, HSDPA and/or HSUPA) and/or equipment class (e.g., channelization codes assigned) of that subscriber.

As stated hereinabove, some or all of this subscriber specific information may be made available upon logging into the network. For example, each wireless unit subscriber may convey its subscription(s) to a corresponding base station over the uplink access channel after authentication. This subscription information may be transmitted to a base station controller, which, in turn, may transmit this information to a mobile switching center.

It should be noted that the step of accumulating might also include collecting information regarding the subscriber populace within the cell. This subscriber populace information may include, for example, geographical distribution of the number of subscribers. For example, the geographical distribution may include subscribers within close proximity of the cell's associated base station requiring fewer network resources for multicasting, subscribers at the outer periphery of the cell's associated base station requiring greater network resources for multicasting, or some variation in geographical distribution therebetween.

Moreover, this step of accumulating may further include collecting information associated with subscription distribution within the cell. Subscription type for each of the subscribers may be grouped and subsequently examined. Alternatively, subscription distribution may be subsequently examined in conjunction with other individual subscriber or subscriber populace information, such as, for example, geographical distribution of subscribers.

Once subscriber specific information and/or subscriber populace within the cell has been accumulated, the method corresponding with flow chart 200 then receives a multicast subscription service at an assigned multicast rate (step 220). The assignment of the multicast rate may be based on the accumulated information of the previous step. As noted hereinabove, for the purposes of the present disclosure, multicast rate may correspond with one of several multicast streams of content and/or one of several rates in which the stream(s) of content may be multicast.

In an effort to conserve network infrastructure resources and/or the resources at the user subscriber's wireless unit, the multicast rate assigned to the multicast service subscription type may take the individual subscriber and/or subscriber populace information into consideration. Thusly, while the subscriber may have a service type corresponding with one or more particular multicast rates, the multicast rate assigned to that multicast service subscription type may vary in accordance with individual subscriber and/or subscriber populace information. This varying of a multicast rate to the multicast service subscription type may involve prioritization. Here, the multicast rate assigned to the multicast service subscription type, from the perspective of the network and service(s) provider, may aim to maximize the total number of subscribers that may receive the multicast. Alternatively, prioritization may take into consideration the goal of offering subscribers with the highest service level (or lowest service level) a maximum multicast rate first before addressing the remaining lower service level(s), again from the perspective of the network and service(s) provider.

Various other combinations are contemplated herein by the present disclosure. For example, the availability of one or more multicast service subscription types may be also scaled. This scaling may be performed in response to the base station resources, such as transmit power. As a consequence, this scaling step may include dropping and/or adding the availability of at least one of the multicast service subscription.

In an alternate example of prioritization, the availability of at least one multicast service subscription type may be scaled in response to a demand from the multicast service subscriber associated with at least another service, for example. This demand may correspond with power required by the wireless unit, the availability of channelization codes and/or subscription fees, for example. Thusly, the step of scaling may include dropping and/or adding the availability of at least one of the multicast service subscription types before receiving the multicast service at an assigned rate.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center, and employed in conjunction with various multiple access schemes, such as CDMA and OFDMA, for example. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contempiated that the appended claims will cover any such modifications or embodiments as fall within the true scope of the invention.

1. A method of wireless communication with a number of subscribers to a subscription-based service, the method comprising:
assigning at least one service rate to at least one of a number of subscription-based service types in response to at least one of channel conditions, power requirements, service subscription type, desired content, other services and equipment class of each subscriber.

2. The method of claim 1, wherein the subscription-based service comprises at least a multicast service, the at least one service rate comprises at least one multicast rate, and each of the subscription-based service type comprises at least a multicast service subscription type.

3. The method of claim 2, wherein the multicast service subscription type comprises at least one of a basic type and a premium type.

4. The method of claim 3, wherein the least one multicast rate is assigned to each multicast service multicast service subscription type in further response to determining a geographical distribution of the number of multicast service subscribers and determining a subscription distribution of the number of multicast service subscribers.

5. The method of claim 4, comprising:
determining the number of multicast service subscribers within a cell;
determining at least one of a geographical distribution of a number of multicast service subscribers and a subscription distribution of the number of multicast service subscribers within the cell; and
wherein the step of assigning at least one multicast rate is performed in further response to at least one of the determined geographical distribution and the determined subscription distribution.

6. The method of claim 4, comprising:
multicasting information to each of the multicast service subscribers at each multicast service subscription type's assigned multicast rate.

7. The method of claim 6, wherein the step of assigning comprises:
prioritizing the assigning of the at least one multicast rate to support the multicasting information to at least one of a maximum number of multicast service subscribers, a maximum number of multicast service subscribers having the premium service type, and a maximum number of multicast service subscribers having the basic service type.

8. The method of claim 7, comprising:
scaling an availability of at least one of the multicast service subscription types in response to a demand from the multicast service subscribers associated with at least another the multicast service subscription type.

9. The method of claim 8, wherein the step of scaling comprises at least one of dropping and adding the availability of at least one of the multicast service subscription types.

10. The method of claim 8, wherein the demand corresponds with at least one of power and subscription revenue.

11. The method of claim 7, comprising:
scaling an availability of at least one of the multicast service subscription types in response to base station resources in use.

12. The method of claim 11, wherein the step of scaling comprises at least one of dropping and adding the availability of at least one of the multicast service subscription.

13. The method of claim 11, wherein the equipment class corresponds with at least one supporting channelization code.

14. The method of claim 2, wherein the other services comprises at least one of voice, HSDPA and HSUPA.

15. A method of wireless communication comprising:
receiving a subscription-based service at an assigned service rate, the assigned service rate corresponding with at least one of service subscription type, desired content, channel conditions, power requirements, other services and equipment class.

16. The method of claim 15, wherein the subscription-based service comprises at least a multicast service, the at least one service rate comprises at least one multicast rate, and the service subscription type comprises at least a multicast service subscription type.

17. The method of claim 16, wherein the assigned multicast rate further corresponds with at least one of a geographical distribution of a number of multicast service subscribers and a subscription distribution of the number of multicast service subscribers within a cell.

18. The method of claim 16, wherein the multicast service subscription type comprises at least one of a basic type and a premium type.

19. The method of claim 16, comprising:
prioritizing the other services and the multicast service subscription service.

20. The method of claim 19, comprising:
scaling the multicast service subscription types available for assigning in response to a change in demand for the other services.

21. The method of claim 20, wherein the step of scaling comprises at least one of dropping and adding support for at least one of the multicast service subscription types.

22. The method of claim 21, wherein the demand corresponds with at least one of power, channelization codes, and subscription fees.

23. The method of claim 19, wherein the other services comprises at least one of voice, HSDPA and HSUPA.

24. The method of claim 16, wherein the equipment class corresponds with at least one supporting channelization code.
